(19) United States
(12) Patent Application Publication
(10) Pub. No.: US 2017/0104283 A1
(43) Pub. Date: Apr. 13, 2017

(54) APPARATUS FOR MAKING CONTACT WITH AN ELECTRICAL CONDUCTOR, AND CONNECTION OR CONNECTING DEVICE WITH AN APPARATUS OF THIS KIND

(71) Applicant: PFISTERER KONTAKTSYSTEME GMBH, Winterbach (DE)

(72) Inventor: Erich FRANK, Hochdorf (DE)

(73) Assignee: PFISTERER KONTAKTSYSTEME GMBH, Winterbach (DE)

(21) Appl. No.: 15/318,018

(22) PCT Filed: Jun. 5, 2015
(86) PCT No.: PCT/EP2015/001140

§ 371 Date: Dec. 12, 2016

(30) Foreign Application Priority Data
Jun. 12, 2014 (DE) 10 2014 008 756.5

(51) Int. Cl. H01R 11/01; H01R 4/26

(52) U.S. Cl. CPC H01R 11/01; H01R 4/26

(57) ABSTRACT

The invention relates to an apparatus (1) for making contact with an electrical conductor (10, 20), in particular a cable conductor of a power supply cable, wherein the apparatus (1) has a connecting body (4) which delimits a receiving space (6) into which the conductor (10, 20) with which contact is to be made can be inserted by way of its end, and wherein the apparatus (1) has a contact medium (30) with which electrical contact can be made with the end of the conductor (10, 20) under the action of a contact force, characterized in that the contact medium (30) has a large umber of electrically conductive contact bodies (32) which are introduced into the receiving space (6) and bear against one another and of which at least some can be brought into electrical contact-making contact with the end of the conductor (10, 20).

The invention relates to an apparatus for making contact with an electrical conductor, in particular a multi-wire conductor of a power supply cable, and a connection or connecting device with such an apparatus.

In order to reduce losses during power transmission in the case of cable conductors with large cross sections of, for example, more than 100 mm²—and in particular more than 1000 mm²—in medium and high voltage cables, conductor designs formed from individual wires are increasingly used, in which insulating materials are inserted between the individual wires or between segments constructed from individual wires, or in which the individual wires are coated with insulating materials. Such conductor constructions minimize the undesirable skin and proximity effects, in particular in the case of large cross sections, so as to increase the transmission capacity of the cable or work with smaller cross sections.

The conductors are preferably divided into several segments, which are put together using tapes or other insulating layers to form conductors with a circular cross section. Inside the segments, the individual wires, which may also be insulated from one another, are twisted and drawn through a form mold, so that the current is subsequently conducted in the individual wires always following the wire course in the longitudinal direction of the cable from the external layer into the inside of the conductor. The segments are usually bound on the outside with tapes during production and are electrically insulated from one another. Such cable conductor constructions are known, for example, from U.S. Pat. No. 1,904,162 A and are also referred to as a MILLIKEN design.

The economic advantage of this construction in terms of optimization of material costs has to be weighed against the disadvantage that the conductor preparation during installation requires significant effort and time to ensure that even the inner-lying wires of the conductor can make contact with the connecting point and can thus contribute to the power transmission. The insulating materials usually have to be completely removed from the conductor assembly. The individual wires must be freed from the insulating materials, in other words, unbent and brushed, and then the individual wires are again brought together manually with the aid of hose clamps and pressing tools to form an almost circular shape with the diameter of the original conductor so that they can be introduced into the connecting element and adequately compressed and retained by it. The effectiveness of these measures is dependent on the care taken during assembly.

An apparatus with the features of the preamble of Claim 1 is known from EP 2 226 899 A1, in which apparatus a wedge-shaped lug acting as a contact medium can be radially screwed into a tubular clamping body, and can thus be brought into contact-making contact with the front ends of the two conductors which are axially inserted into the clamping body at opposite sides, thus allowing an electrical connection to be established between the two conductors.

The problem addressed by the invention is to provide an apparatus for making contact with an electrical conductor, in particular a multi-wire conductor of a power supply cable, and a connection or connecting device with such an apparatus, which remedy the disadvantages of the prior art. In one embodiment, in particular the assembly of such apparatuses and thus the production of connection or connecting devices according to the invention is to be simplified while constantly ensuring a high level of contact reliability and a high current-carrying capacity.

This problem is solved by means of the apparatus defined in Claim 1 and by means of the connection or connecting device defined in the coordinate independent claim. Particular embodiments of the invention are defined in the dependent claims.

In one embodiment, the apparatus according to the invention for making contact with an electrical conductor, in particular a cable conductor of a power supply cable, has a connecting body, into which the conductor with which contact is to be made can be inserted by means of its front end; the apparatus also has a contact medium, with which electrical contact can be made with the front end of the conductor and which has a plurality of electrically conductive contact bodies, of which at least some can be brought into electrical contact-making contact with the front end of the conductor, and preferably with the entire front end of the conductor; thanks to the contact bodies, the contact force can be transmitted to adjacent contact bodies and/or to the conductor with which contact is to be made and/or to the connecting body, in particular from a force application point of the connecting body, for example, a pressure screw which can be screwed into the connecting body, as far as the front surface of the conductor with which contact is to be made. An apparatus according to the invention can be used for electrically connecting two or more conductors as well as for the connection of one or more conductors to an electrical appliance.

The connecting body can be in one part, which simplifies, for example, the absorption of the clamping forces and contact forces applied, or in multiple parts, which simplifies, for example, the assembly of the apparatus because already laid cables, for example, no longer have to be moved in the longitudinal direction during installation, instead the cable ends can swing sideways to the connection point or the other cable end, which is advantageous particularly in the case of large conductor cross sections. The connecting body can be at least partially sleeve-shaped, so that the conductor with which contact is to be made or the conductors to be connected to one another can be inserted into or laid in the sleeve-shaped section. At least some and preferably all of the contact bodies can have an identical shape and preferably also an identical size.

The invention offers particular advantages in the case of making contact with multi-wire conductors, for example of cable conductors of the MILLIKEN design. The present invention substantially improves the functional level of the connections known from the prior art because it is not, or at least not only, the circumferential surface at the conductor end which is used for the power transmission, as was previously the case, but also or even exclusively the front side of the conductor, and preferably the entire front surface of the conductor. In addition, this design permits the use of relatively compact connecting systems, which require less installation space and thus allow smaller, easier to install and more cheaply produced installation systems to be used in fittings.

The front surface of the conductor increases geometrically proportional to its cross section. In all of the different prior art conductor constructions, the front side is the only surface which can be particularly easily provided as a bare metal object. The cables are thus usually shortened upon installation to the appropriate length, and are preferably cut. All other surfaces of the conductor which are to be made contact with must be prepared in a separate operation using more or less effort.

Unlike the conventional molding and screwing technology, in the apparatus according to the invention, no transverse force needs to be applied to the conductor at the clamping point in order to establish the electrical transverse conductivity between the individual wires and the connecting body. This is advantageous because such a transverse conductivity becomes more difficult to achieve with larger cross sections and/or partially insulated conductor constructions.

The electrical and mechanical functions of the contact apparatus can be divided into two sections which can also be spatially separated from one another or even spaced apart, namely, a first section, which is responsible for the transportation of electricity and provides a low electrical resistance with short current paths using metal masses with good thermal conductivity, and a second section, which is responsible for the mechanical fixation and force transmission and which provides, with a smaller design size, a high mechanical strength and a robust design which is suitable for the construction site with adequate tolerance to differences between planned and delivered conductor design, thus ensuring an error-proof and time-saving installation.

Apparatuses according to the invention can thus be designed very narrow and compact because the current conduction runs directly from one conductor end to the other conductor end or to a contact surface. The sleeve-shaped connecting body is designed primarily for the mechanical stress requirement, which requirement can be satisfied with the use of high-strength materials with smaller wall thicknesses than those conventionally used. This permits the use of smaller and cheaper insulating bodies of cable fittings.

In one embodiment of the invention, the contact force can be transmitted in an essentially direction-independent manner to adjacent bearing contact bodies, and/or the conductor to be made contact with and/or the connecting body. This ensures a pressure distribution, and thus a force distribution, which is virtually hydrostatic. This results in the electrical contacting of the conductor occurring over a short connecting distance.

In one embodiment of the invention, at least part of the contact bodies has an at least partially curved surface, in particular an at least partially spherical surface, and preferably at least part of the contact bodies is formed ball-shaped. Contact bodies formed in this way permit a force transmission between the contact bodies and/or the conductor with which contact is to be made and/or the connecting body which is particularly advantageous for the electrical contacting. In particular, the use of balls as contact bodies is advantageous because they allow in a simple manner an isotropic force distribution.

In one embodiment of the invention, the electrically conductive contact bodies have an electrically conductive surface coating, which constantly has a lower contact resistance compared with the material of the contact bodies. While the contact bodies can be made, for example, from copper or aluminum, the coating can be made, for example, from gold or silver or also from tin or zinc, or also from an alloy using at least one of these elements. This permits a constantly low contact resistance to adjacent bearing contact bodies and/or to the conductor with which contact is to be made, in particular to uncoated copper or aluminum conductors, and/or to the connecting body while the contact bodies have a high level of pressure strength.

The thickness of the surface coating can be more than 1 μm and less than 25 μm, in particular more than 2 μm and less than 10 μm, and preferably more than 2.5 μm and less than 6 μm. The size of the contact bodies, in particular of the ball-shaped contact bodies, is to be selected such that, on the one hand, they cannot enter into anticipatable cavities or gaps filled with insulating materials on the conductor front surfaces and, on the other hand, selected small enough that a virtually hydrostatic balance of the contact bodies is achieved in the case of point loading and, as far as possible, every individual wire is contacted on the front side of at least one, and preferably of at least two, contact bodies. In the case of ball-shaped contact bodies, the ball diameter should be selected significantly smaller than the individual wire diameter of the conductor.

In one embodiment of the invention, the contact medium has a pasty mass which is preferably tough-elastic at room temperature, in which the contact bodies are embedded. This is also advantageous for the installation, because the positioning and dosing of the contact bodies is simplified and, by comparison, the handling of loose contact bodies, in particular of balls, is problematic on the installation site. The mass can permit a homogeneous distribution of the contact bodies, and/or a dimensionally-stable application of the contact bodies to the prepared conductor front surface, and/or cannot adhere to the installation tool when used as intended, and/or can prevent an oxidation of the electrical contacts, and/or cannot spread into remaining cavities and cannot react chemically with the known insulating materials, and/or cannot change the electrical properties of a conductor smoothing layer or of the cable primary insulation.

In one embodiment, the apparatus has a force application element acting on the contact medium and in particular on the contact bodies, by means of which the contact force can be applied to the contact medium. The necessary contact force can be generated after the introduction of the contact bodies into the receiving space delimited by the deformation body and the conductor with which contact is to be made, for example, by means of one or more pressure screws which can be screwed into the deformation body.

In one embodiment, the apparatus has a force storage means acting on the contact medium and, in particular, the contact bodies, by means of which the contact force can be constantly maintained. The minimum holding force required for uninterrupted operation should be balanced and maintained by means of a suitable spring accumulator once all settling losses have disappeared and taking into account the operation-related reversible volume changes due to thermal expansion of the materials. The force storage means can also be integrated into the force application element. The desired pre-tension can be applied in a simple manner by the installer by means of tightening of the pressure screw(s) and controlled by means of the torque to be applied, for example, also by means of screws with tear-off heads. Alternatively or additionally, indicators can indicate that the springs are adequately tensioned. The installer thus receives clear feedback that the assembly has been correctly realized and the connection can thus satisfy the requirements during operation.

In one embodiment, the apparatus has at least one force indicator or at least one signal element, each of which indicates that the contact medium is adequately tensioned by means of the force storage means or contact storage means. Such an indication, for example, with signal elements in the form of force indicators simplifies the assembly while simultaneously ensuring a relatively narrowly tolerated tensioning of the contact means.

In one embodiment, the apparatus has a fixation device for fixing the conductor with which contact is to be made to the connecting body, in particular for fixing the axial position of the conductor with which contact is to be made relative to the connecting body. The fixation device in particular absorbs forces in the longitudinal direction of the conductor which act on the conductor from the outside during the installation and during the operation. In a multi-wire conductor, for example, the fixation device fixes the individual wire assembly at the clamping point in the transverse direction of the conductor, clamps the individual wires at the front side of the prepared conductor ends in a maximally form-fitting manner and forms a stable counter bearing for the contact bodies which are under pressure from the contact force.

The invention also relates to a connection and connecting device with an apparatus as described above and with a contacted electrical conductor, in particular a multi-wire cable conductor of a power supply cable, wherein at least some of the contact bodies are in electrical contact-making contact with the front end of the conductor. This permits in a simple manner a constantly reliable and large-area electrical contacting of the conductor.

In one embodiment, at least part of the contact body has an at least partially curved surface, in particular an at least partially spherical surface, and preferably at least part of the contact bodies is formed ball-shaped. The radius of the curved surface is less than 50% of a narrow side of the front surface of the contacted conductor or of the wires of a multi-wire conductor, in particular less than 40% and preferably less than 25%. This ensures that at least one contact body contacts on every individual wire of the conductor.

In one embodiment, the conductor has multiple wires, and at least one expansion element is inserted into the front end of the contacted conductor, and preferably an expansion element is inserted centrally into the front end of the contacted conductor. A radial widening of the conductor is thus obtained, which is advantageous in order to be able to clamp the conductor at the contact point in a pressure-resistant manner. Without the entry of at least one expansion element in the center of the conductor which, in many conductor constructions, is in any case filled with a soft plastic, which must be replaced due to the required pressure stability, a kind of arch would be created which, in the case of a radial loading from the outside towards the center, undesirably absorbs the pressure load and dissipates it in the circumferential direction. The radially exerted clamping force would then not act on the inner wire layers. Thanks to the widening of the conductor cross section by means of the expansion element, in particular a central pin, the individual wires no longer contact with the adjacent wires and the force acting from the outside is now transmitted onto the wires below and not supported transversely. This allows the clamping force to act as far as the center of the conductor and individual wires are fixed more effectively.

The expansion element can be at least partially conical or wedge-shaped. The expansion element can have one or more sections which can preferably be detached in a tool-free manner so that, after an adequate entry of the expansion element into the conductor, the expansion element can be detached at the front side of the conductor, preferably without the part remaining in the conductor projecting over the front surface of the conductor.

In order to clamp and adequately fix the individual wires of a multi-wire conductor in the radially outermost position, radially acting clamping screws can be used which are arranged, for example, distributed on the circumference of the connecting body. For this purpose, the clamping screws can be arranged at a small spacing on the circumference. If necessary, the clamping screws can be arranged in two or more rows behind one another in the axial direction. Annular cutting edges or tapered surfaces on the heads of the clamping screws are advantageous for a large-area clamping contact of preferably several individual wires.

In order to offset the conductor diameter tolerance encountered in practice, it is advantageous that an adaptation of the connecting body to the actual conductor diameter is obtained. The remaining gap must be smaller than the inserted contact bodies, in order to prevent the contact bodies from entering into the gap. This gap can be adequately reduced during installation for example by means of conical shaping of the conductor receiving hole and axial displaceability of the contact part.

In one embodiment, an annular element is mounted on or near to the front end on the contacted conductor, the external diameter of which is adapted to the receiving space of the connecting body, in particular the external diameter of the annular element can essentially correspond to the clear width of the receiving space of the connecting body; alternatively or additionally, the internal diameter of the annular element can be adapted to the external diameter of the conductor with which contact is to be made, in particular the internal diameter of the annular element can essentially correspond to the external diameter of the conductor with which contact is to be made. A centering of the conductor in the conducting body can thus be achieved and/or the circumferential contour of the conductor, in particular its roundness, can be ensured.

In particular when the annular element is installed before the entry of the expansion element, it serves as a radial delimitation and as fixation of the conductor and ensures the circumferential contour thereof when the expansion element is subsequently introduced and the conductor assembly accordingly attempts to widen radially. At the same time, the form fit between the individual wires is reduced in the transverse direction and improved relative to the annular element. The gap at the external diameter of the conductor closes, the clamping force for the subsequent mechanical fixation of the conductor assembly can act through the clamping screws and as far as the center. Several annular elements with different dimensions can be provided, in particular with different internal diameters, so that, using a connecting body, the selection of a suitable annular element also allows conductors with different dimensions to be contacted.

The following factors must be taken into account during the contacting of conductor front surfaces: The cut front surface of a multi-wire conductor is a bare metal object in the manually executed installation, but it is very rough thanks to corrugations and can also be cut obliquely to the cable direction; these shape variations occurring in the cable preparation are not definable. The front surface, which is available for the contacting, corresponds to the supplied conductor cross section, which is usually somewhat smaller than the nominally specified cross section from the cable's data sheet. The front surface to be contacted can consist of individual wires with diameters which may differ; the individual wires may be covered with thin insulating layers at the wire surface and can have, due to compression during production, different cross-sectional shapes which may differ from the ideal circular shape. The individual wires may not be connected to one another in cross section and can be moved towards one another to a limited extent in the longitudinal and transverse directions; they are held in the longitudinal bracing only by means of twisting and form fitting. Insulating materials in the form of powder, tape or homogeneous plastic fillings can be provided individually or in combination between the individual wires. The insulating materials are usually less pressure-resistant than the front surfaces of the wires and therefore yield under mechanical loading. The relaxation and settling behavior in the case of point and/or planar pressure loading corresponds to the values typical of plastics, which are far below the characteristic values to be expected with pure metals. Larger gussets can be provided between conductor segments and/or centrally inserted hollow conductors or plastic cords.

Further advantages, features and details of the invention emerge from the dependent claims and the subsequent description, in which several exemplary embodiments are described in detail with reference to the drawings. The features mentioned in the claims and in the description can be essential to the invention on their own or in any combination.

FIG. 1 shows a longitudinal section through a first exemplary embodiment of the invention,

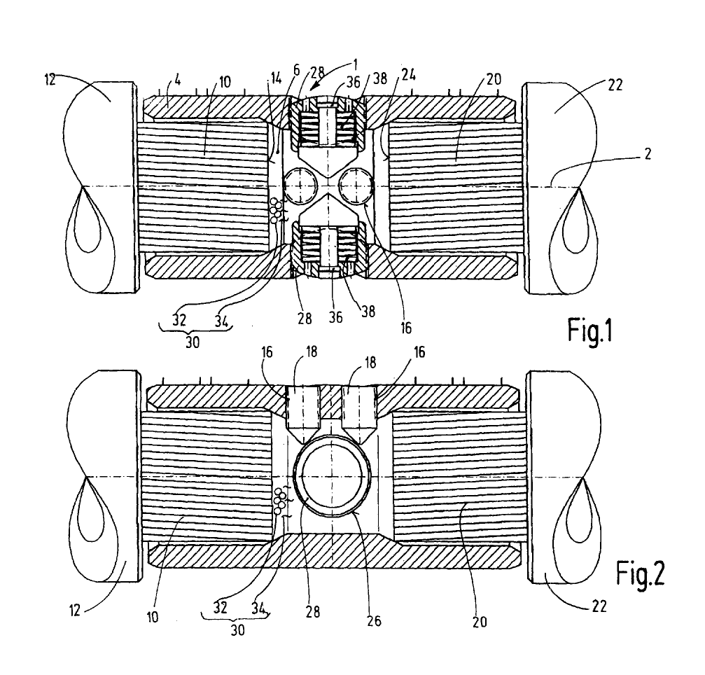

FIG. 2 shows a longitudinal section of the first exemplary embodiment rotated 90° about the longitudinal axis,

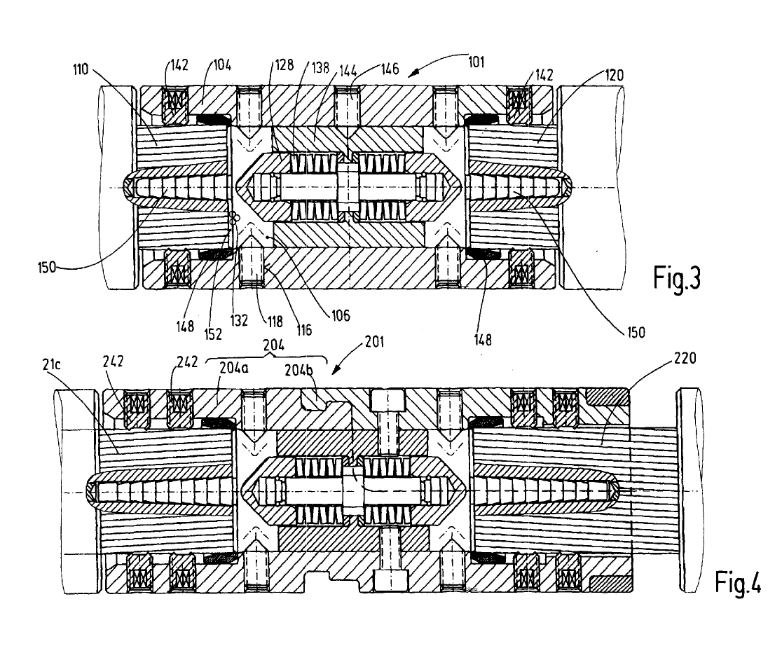

FIG. 3 shows a longitudinal section through a second exemplary embodiment,

FIG. 4 shows a longitudinal section through a third exemplary embodiment,

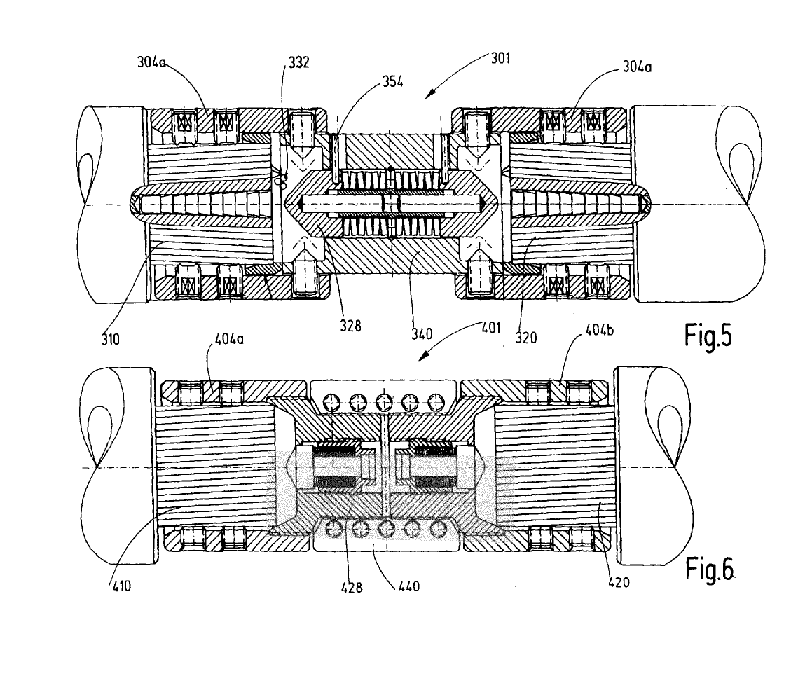

FIG. 5 shows a longitudinal section through a fourth exemplary embodiment,

FIG. 6 shows a longitudinal section through a fifth exemplary embodiment,

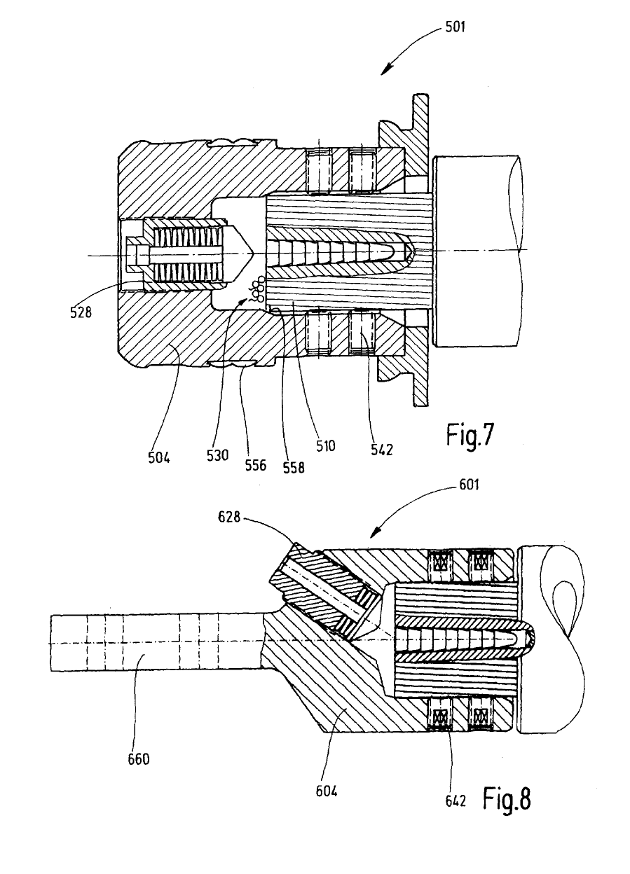

FIG. 7 shows a longitudinal section through a sixth exemplary embodiment, and

FIG. 8 shows a longitudinal section through a seventh exemplary embodiment.

FIG. 1 shows a longitudinal section through a first exemplary embodiment of the invention with an apparatus 1 according to the invention for making contact with a multi-wire electrical conductor 10, in this case for connecting the first multi-wire electrical conductor 10 to a second multi-wire electrical conductor 20, which is the cable conductor 10, 20 of a first power supply cable 12 or of a second power supply cable 22. The two conductors 10, 20 lie in the region of the apparatus 1 coaxial to the longitudinal axis 2 of the apparatus 1. FIG. 2 also shows a longitudinal section through the apparatus 1, in which the apparatus 1 is, however, rotated 90° about the longitudinal axis 2.

The first exemplary embodiment serves to connect conductors 10, 20 having the same cross section and uses as an external contact system the tubular connecting body 4 which, like a normal press connector, is slid onto the prepared ends of the conductors 10, 20 at the left and right and is pressed in, for example, with hydraulic tools. In a similar way to the case of a conventional press connector, with appropriate conductivity the connecting body 4 can also be used for the power transmission of the bare conductor wires of the two conductors 10, 20, which conductor wires are contacted on the surface. Because, however, possible insulating layers were not removed from the individual wires and only the two outer layers are, from experience, involved in the transport of current in the case of multilayer cables, this alone does not establish an adequate electrical contact. The pressing thus ensures in particular that the two ends of the conductors 10, 20 are fixed on the connecting body 4 and are thus connected to one another in a mechanically stable manner.

Because the front ends 14, 24 of the conductors 10, 20 are thus also radially clamped and can only move slightly or not at all in the longitudinal direction, a receiving space 6 is delimited axially by the two conductors 10, 20 and radially by the connecting body 4, into which receiving space contact bodies 32 are introduced, which are embedded in a pasty mass 34 and together with it form the contact medium 30 of the apparatus 1, which is only partially depicted for reasons of clarity.

The contact bodies 32 are formed by balls made from copper, which have a uniform size and are covered with a 3 μm to 5 μm thick layer of tin. The diameter of the balls is more than 10% and less than 100% of the extension of the narrow side of a wire of the conductor 10, 20, in particular more than 15% and less than 90% and preferably more than 20% and less than 85%. The pasty mass 34 can comprise a silicone gel or another paste with suitable viscosity.

After the introduction of an adequate quantity of the contact medium 30, for example via the two first threaded openings 16 abutting the receiving space 6 and arranged one behind the other along the longitudinal axis 2, a threaded pin or a tear-off screw acting as a force application element 18 is screwed into these threaded openings 16 and the receiving space 6 is thus closed and the contact medium 30 is placed under pressure with further screwing in.

The apparatus also has two force storage means 28, which each have a set of disk springs 38 and are inserted into the connecting body 4 radially at sides which are axially opposite one another, and in particular are screwed into corresponding second threaded holes 26 and then stuck therein. The two force application elements 18 are screwed into the connecting body 4 and tightened until force indicators in the form of signal elements 36 on the force storage means 28 indicate that the contact medium 30 is adequately tensioned. The force storage means 28 are dimensioned such that they maintain the minimum necessary holding force even if, due to thermal load changes and constant relaxation losses, the volume between the two conductors 10, 20 were to expand or the ends of the two conductors 10, 20 were to nevertheless move a little.

FIG. 3 shows a longitudinal section through a second exemplary embodiment of the invention with an apparatus 101, in which a one-part tube is pushed as a connecting body 104 over the ends of the two different or cross-sectionally identical conductors 110, 120. The two conductors 110, 120 are then fixed by means of the axially outermost holding screws 142 to the connecting body 104, which form part of a fixing device of the apparatus 301; the central part 144 with the force storage means 128 or spring sets 138 is already installed in the connecting body 104 and fixed there axially and radially at the center. With such a design, a portion of the current load can flow over the holding screws 142 and the connecting body 104, however this is not absolutely necessary and thus permits more compact designs of the apparatus 101. An advantage of this exemplary embodiment is that all connections can be tightened with customary tools for attachment devices and no special tools are required.

The preferably ball-shaped contact bodies 132 are introduced via the still open holes 116 for the force application elements 118, until the receiving space 106 between the conductors 110, 120 is completely filled. The contact force is applied by means of the force application elements 118, which are formed, for example, by threaded pins and which are finally screwed into the holes 116 and tightened, until no screw protrusion can be seen.

The centering screw 146 in the center of the connecting body 104 fixes the pre-tensioned force storage means 128 with their sets of disk springs 138. By means of torque-controlled tightening of the total of four force application elements 118 of the dimension M12, the contact bodies 132 are placed under pressure and the force storage means 128 are pre-tensioned.

The connecting body 104 can be formed by a tube or also by connectable half shells, which can be placed around the conductors 110, 120 and clamped by means of a suitable device relative to one another and to the conductors 110, 120.

An annular element 148 is mounted on the two conductors 110, 120 at their front end, the external diameter of which is adapted to the receiving space 106 of the connecting body 104, and in particular essentially corresponds to the clear width of the receiving space 106 of the connecting body 104, and the internal diameter of which is adapted to the external diameter of the conductor 110, 120 with which contact is to be made, in particular essentially corresponds to the external diameter of the conductor 110, 120 with which contact is to be made. The conductors 110, 120 are thus centered in the connecting body 104 and their circumferential contour is ensured and is preferably circular. The annular elements 148 extend over the front end of the conductor 110, 120 while forming an annular bar 152 directed radially inwards, which forms a stop when the annular element 148 is slid onto the conductor 110, 120.

An expansion element 150 is inserted centrally into the front end of the two conductors 110, 120, which expansion element has several sections, at least a portion of which are frusto-conical and which can be detached from one another in a preferably tool-free manner. The contour of the depicted longitudinal section through the expansion element 150 is also conical, so that the associated conductor 110, 120 is expanded all the more and is thus pressed into contact with the inside of the annular element 148 the further the expansion element 150 is introduced into the conductor 110, 120.

FIG. 4 shows a longitudinal section through a third exemplary embodiment of the invention with an apparatus 201, the installation of which is simplified in that a second part 204b, in particular a second half, of the two-part or multiple-part tubular connecting body 204 can be taken off a first part 204a and mounted on the first part 204a again and fixed there, for example, with a ring, once the connecting body 204 is in the right position relative to the conductors 210, 220. It is also possible for both sides of the connecting body 204 to be formed in such a way.

For the installation, one side of the connecting body 204 is pushed onto the end of the first conductor 210 and fixed there by means of the holding screws 242. In the axial direction, two or more rows of holding screws 242 which are preferably equidistantly spaced apart in the circumferential direction can be provided, wherein the holding screws 242 of adjacent rows can be offset relative to one another in the circumferential direction, so that several and preferably all individual wires of the conductors 210, 220 are clamped. The end of the second conductor 220 can then be inserted into the open half shell on the other side of the connecting body 204 and, in particular, must not be pushed in in the longitudinal direction. This is advantageous because an axial movement of such cable conductors is only possible by application of significant forces due to their large dimensions.

FIG. 5 shows a longitudinal section through a fourth exemplary embodiment of the invention with an apparatus 301, in which a first part 304a of the connecting body is mounted on an end of a conductor 310, 320. The two first parts 304a are then connected with a connecting element 340, which is in turn connectable with the two first parts 304a. The contact bodies 332 are introduced and compressed and placed under pressure by means of screwing in of the force application elements 318. The ensuing pre-tensioning on the force storage means 328 can be measured from outside the apparatus 301 by means of the axial position of pin-shaped signal elements 354, which are arranged in the force storage means 328 and extend radially outwards and penetrate radial holes in the connecting element 340. When the conical sections of the force storage means move, for example, axially to the center of the apparatus 301, the signal element 354 is carried along and, at the axial position of the signal element 354, it is possible to measure from outside the apparatus 301 to what extent the force storage means 328 are pre-tensioned.

In one modified embodiment, the radial hole in the connecting element 340 for the passage of the signal element 354 can be only insignificantly larger than the dimension of the signal element 354, so that no axial relative movement of the signal element 354 relative to the connecting element 340 is possible. Instead, the receiving opening for the signal element 354 provided in the force storage means 328 has an angular face so that, in the case of an axial relative movement of the force storage means 328 relative to the connecting element 340, the signal element 354 slides along the angular face and is thus moved radially in the radial hole, so that the pre-tensioning of the force storage means 328 can be measured from outside the apparatus 301 by means of the radial position of the signal element 354. For example, the signal element 354 is only visible or is flush with the connecting element 340 when the force storage means 328 is adequately pre-tensioned and the contact force is thus adequate. The signal element 354 can be able to be moved axially and/or radially under a spring force load in order to eliminate the influence of the weight force, for example.

FIG. 6 shows a longitudinal section through a similarly three-part fifth exemplary embodiment of the invention with an apparatus 401, in which the two first parts 404a of the connecting body are also each mounted on an end of a conductor 410, 420, however, these two first parts 404a are then connected with a multi-part connecting element 440, for example by means of two half shells which can be screwed to one another. A holding body of the force storage means 428 surrounding the spring elements can project into the two first parts 404a of the connecting body axially by means of its two axial end sections opposite one another, in particular, it can have an external thread at the end and thus be able to be screwed into the two first parts 404a, and can form an axial stop for the ends of the two conductors 410, 420 by means of an end inside taper section.

One advantage of the described three-part exemplary embodiments is that both conductor ends can be mounted in advance individually and independently of one another. The pushing on of the two ends of the apparatus 301,401 assigned to the conductors 310, 410, 320, 420 is thus very easily achievable, in particular the associated cables do not have to be moved for this purpose. When the central connecting element 340, 440 is screwed on, the conductors 310, 410, 320, 420 are centered and the front sides are firmly clamped.

The two ends thus mounted in advance are moved into a coaxial position and electrically and mechanically connected with the half shells. The half shells can also consist of more than two segments. The form fitting for the mechanical and electrical connection can take place by means of a thread or circumferential grooves. The form-fitting connection of the individual parts of the connection improves the mechanical strength. The minimizing of remaining cavities increases the mass percentage and improves the low-loss power transmission.

FIG. 7 shows a longitudinal section through a sixth exemplary embodiment of the invention with an apparatus 501, which can be used for a plug-in system with lamellar contacts. In the case of such a pluggable connection part, there are generally no significant demands made with respect to the axial tensile loading capacity of the conductor connection. The conductor front surface is prepared and the connecting or connection body 504 is pushed on. The connecting body 504 has a circumferential groove on the outside, into which a contact lamella 556 is inserted.

The connecting body 504 is filled with the contact medium 530 and pushed onto the end of the conductor 510 and mechanically fixed on the conductor end by means of the holding screws 542. A conical surface 558 on the connecting body 504 realizes the centering and the sealing of the edge of the front surface of the conductor 510. The contact force is then pre-tensioned by means of the force storage means 528, which can be screwed into the connecting body 504 on the front side opposite the conductor 510.

FIG. 8 shows a longitudinal section through a seventh exemplary embodiment of the invention with an apparatus 601, which can be used, for example, for screw connection bolts on cable terminations and can be constructed according to the same design principle as the previously described apparatuses. The end section for receiving the connection fitting of an open wire or the screw connection to a busbar system can be designed, depending on the application, for example as massive round bolts, as a flat rectangular connecting lug with holes, or—as depicted with dashed lines in FIG. 8—as a cable shoe 660. At the cable conductor end, a screwed embodiment with holding screws 642 is depicted by way of an example, with compressed embodiments or other embodiments of the connection types also being possible.

The force storage means 628 can be screwed into a hole in the connecting body 604, which hole creates an acute angle with the longitudinal axis of the apparatus 601 of preferably more than 15° and less than 80°, in particular more than 20° and less than 65°, and preferably more than 30° and less than 45°.

1. An apparatus (1) for making contact with an electrical conductor (10, 20), in particular a cable conductor of a power supply cable, wherein the apparatus (1) has a connecting body (4), which delimits a receiving space (6), into which the conductor (10, 20) with which contact is to be made can be inserted by means of its front end, and wherein the apparatus (1) has a contact medium (30) with which electrical contact can be made with the front end of the conductor (10, 20) under the action of a contact force, characterized in that the contact medium (30) has a plurality of electrically conductive contact bodies (32) which are introduced into the receiving space (6) and bear against one another and of which at least some can be brought into electrical contact-making contact with the front end of the conductor (10, 20).

2. The apparatus (1) according to claim 1, characterized in that the contact force of one contact body (32) can be transmitted to adjacent bearing contact bodies (32) and/or the conductor (10, 20) with which contact is to be made and/or the connecting body (4).

3. The apparatus (1) according to claim 1, characterized in that the contact bodies (32) are shaped such that the contact force can be transmitted in an essentially direction-independent manner to adjacent bearing contact bodies (32) and/or the conductor (10, 20) with which contact is to be made and/or the connecting body (4).

4. The apparatus (1) according to claim 1, characterized in that at least part of the contact bodies (32) has an at least partially curved surface, in particular an at least partially spherical surface, and preferably at least part of the contact bodies (32) is formed ball-shaped.

5. The apparatus (1) according to claim 1, characterized in that the contact bodies (32) have an electrically conductive surface coating, which constantly has a lower contact resistance compared with the material of the contact bodies.

6. The apparatus (1) according to claim 1, characterized in that the contact medium (30) has a pasty mass (34), in which the contact bodies (32) are embedded.

7. The apparatus (1) according to claim 1, characterized in that the apparatus (1) has at least one force application element (18) acting on the contact medium (30), by means of which the contact force can be introduced into the contact medium (30).

8. The apparatus (1) according to claim 1, characterized in that the apparatus (1) has a force storage means (28) acting on the contact medium (30), by means of which the contact force can be constantly maintained.

9. The apparatus (1) according to claim 1, characterized in that the apparatus (1) has at least one force indicator (36) or at least one signal element (354), which indicates that the contact medium (30) is adequately tensioned by means of the force storage means or contact storage means (28).

10. The apparatus (1) according to claim 1, characterized in that the apparatus (1) has a fixation device for fixing the conductor (10, 20) with which contact is to be made to the connecting body (4), in particular for fixing the axial position of the conductor (10, 20) with which contact is to be made relative to the connecting body (4).

11. A connection or connecting device with an apparatus (1) according to claim 1 and with a contacted electrical conductor (10, 20), in particular with a multi-wire cable conductor of a power supply cable, wherein at least some of the contact bodies (32) are in electrical contact-making contact with the front end of the conductor (10, 20).

12. The connection or connecting device according to claim 11, characterized in that at least part of the contact bodies (32) has an at least partially curved surface, in particular an at least partially spherical surface, and preferably at least part of the contact bodies (32) is formed ball-shaped, and in that the radius of the curved surface is less than 50% of a narrow side of the front surface of the contacted conductor (10, 20) or of the wires of a multi-wire conductor (10, 20), in particular less than 40% and preferably less than 25%.

13. The connection or connecting device according to claim 11, characterized in that the conductor (10, 20) has multiple wires, and that at least one expansion element (150) is inserted into the front end of the contacted conductor (10, 20), preferably that an expansion element (150) is inserted centrally into the front end of the contacted conductor (10, 20).

14. The connection or connecting device according to claim 11, characterized in that an annular element (148) is mounted on or near to the front end on the contacted conductor (10, 20), the external diameter of which is adapted to the receiving space (6) of the connecting body (4), in particular that the external diameter of the annular element (148) essentially corresponds to the clear width of the receiving space (6) of the connecting body (4), and/or the internal diameter of which is adapted to the external diameter of the conductor (10, 20) with which contact is to be made, in particular that the internal diameter of the annular element (148) essentially corresponds to the external diameter of the conductor (10, 20) with which contact is to be made.
